(19) United States
(12) Patent Application Publication
(10) Pub. No.: US 2021/0238055 A1
(43) Pub. Date: Aug. 5, 2021

(54) Alkaline Water Filter for Refrigerator

(71) Applicant: Alfredo Carlos Neuman, Spring, TX (US)

(72) Inventor: Alfredo Carlos Neuman, Spring, TX (US)

(21) Appl. No.: 17/133,629

(22) Filed: Dec. 24, 2020

Related U.S. Application Data
(60) Provisional application No. 62/967,588, filed on Jan. 30, 2020.

(51) Int. Cl. C02F 1/00; C02F 1/68; C02F 5/08; C02F 1/66; A23L 33/16; F25D 29/00

(52) U.S. Cl. CPC C02F 1/003; C02F 1/68; C02F 5/083; C02F 2103/04; A23L 33/16; F25D 29/006; C02F 1/66

(57) ABSTRACT

The present invention relates to new and useful improvements in the method of purifying water. The refrigerator has a storage chamber therein for a water filter device with a coconut shell activated carbon rod installed in the storage chamber to purify water supplied from an external water supply source.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

### Field of the Invention

The present invention relates to water filters and, more particularly, to the refrigerator mounted alkaline water filters.

### Description of the Related Art

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

In recent years, as the public has begun to realize the benefits derived from drinking water and, preferably, highly pure water, there has been a great increase in the sale and availability of household water filtration devices. Concurrently, refrigerator mounted water dispensers and automatic ice makers have become more affordable, and more commonplace. In response to this fact, there have been attempts to incorporate water filters into household refrigerators to provide a filtered water supply for direct dispensing via the refrigerator water dispenser, or for use in making ice cubes via an automatic ice maker.

Recently-developed refrigerators tend to accomplish desired purposes of appliances equipped therein by filtering tap water (raw water) using a water filter device, and thus obtaining clear water (purified water).

The proposed invention relates to water filters for the refrigerator. Such an alkaline filter is used to filter water to be dispensed to improve the taste and appearance of the water and can be arranged to remove undesirable chemicals from the water.

None of the prior art methods have been found to be completely suitable to meet these needs and are cumbersome. The present invention provides such a method and the overall combination of these features is nowhere disclosed in the prior art cited above which appears to be representative of the general art in this area although it is not intended to be an all-inclusive listing of pertinent prior art patents.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, and abstract as a whole.

In order to solve the above problems, the method and system of this invention focus alkaline water filters that are guaranteed to reduce contaminants, for fresh-tasting water.

Another embodiment of the present invention is adapted to revolutionized technology for alkaline water filtration, which helps for chlorine reduction which may be present in the water.

Another object is to provide a novel constructions for the filter with coconut shell activated carbon rod to get alkaline water from refrigerator.

It is another object of this invention to provide the filter through which water goes through the coconut shell activated carbon rod where the chloride is reduced and the PH+Alkalinity is increased. Then the water is sent back to the fridge to be dispensed on ice cubes or water for consumption.

Briefly, it is a principal object of the invention to remove the unpleasant odor and harmful components in the beverage, an object of the present invention is to provide mineral increased the (alkaline component) “healthy delicious water” is obtained at all time from the household refrigerator.

It is thus a primary object of the present invention to provide a filter that will universally fit in every shape and brand.

One feature of the invention is that the water filter device includes a filter unit to receive water from an external water supply source and to purify the received water, a storage tank unit to store the water purified through the filter unit, and a case to dispense the filtered water.

As known the water flows inside a charged carbon rod that filters chlorine and releases minerals which makes it alkaline.
The minerals are: Sodium, Potassium, Magnesium & Calcium
The performance tested and claimed per filter are: Duration 300 Gallons
Reduction chlorine (NSF 42) 85%
PH output 8.5-9
Alkalinity 90

This Summary is provided merely for purposes of summarizing some example embodiments, to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 100 is a full view of the alkaline filter.

FIG. 200 shows a coconut shell activated carbon rod.

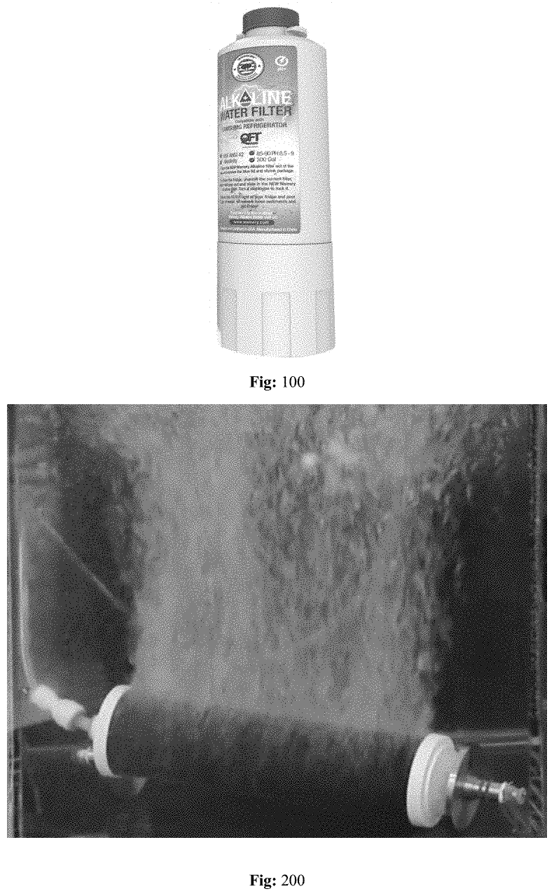

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

Unless otherwise defined, all terms (including technical and scientific terms) used herein have the same meaning as commonly understood by one having an ordinary skill in the art to which the invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques are disclosed. Each of these has individual benefit and each can also be used in conjunction with one or more, or in some cases all, of the other disclosed techniques. Accordingly, for the sake of clarity, this description will refrain from repeating possible combination in an unnecessary fashion. Nevertheless, the specifications and claim/s should be read with the understanding that such combinations are entirely within the scope of the invention and the claim/s.

The method of the present invention is that it relates on a method and system which focuses to alkaline water filters that are guaranteed to reduce contaminants, for fresh-tasting water. A novel constructions for a filter with coconut shell activated carbon rod to get alkaline water from refrigerator.

Those skilled in the art will understand that the water filter apparatus according to the invention can be used with water only dispensing apparatus in any refrigerator freezer configuration, and can be located in either a refrigerator compartment door or a freezer compartment door. Similarly, those skilled in the art will understand that a water filter apparatus according to the invention can be used with any appliance having a water dispensing mechanism in which it would be desirable to incorporate a water filter to improve the taste and appearance of water dispensed.

It is another object of this invention to provide the filter through which water goes through the coconut shell activated carbon rod where the chloride is reduced and the PH±alkalinity is increased. Then the water is sent back to the fridge to be dispensed on ice cubes or water for consumption.

The invention removes Chlorine in compliance with NSF/ANSI 42 along with other harmful materials that may be present, meanwhile increases the PH and Alkalinity of the water that goes through it.

As known the water flows inside a charged carbon rod that s chlorine and releases minerals which makes it alkaline.
The minerals are: Sodium, Potassium, Magnesium & Calcium
The performance tested and claimed per filter are: Duration 300 Gallons
Reduction chlorine (NSF 42) 85%
PH output 8.5-9
Alkalinity 90

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1) An alkaline filter cartridge for the refrigerator that helps to purify the drinking water and thus PH+Alkalinity is increased.

2) The said filter in claim 1, is inserted into the refrigerator to get alkaline ice and water from the fridge dispenser.

3) Coconut shell activated carbon rod to get PH+Alkalinity and to soften the water from refrigerators to make it consumable.

4) The said Alkalinity in claim 1, As the water flows inside a charged carbon rod that filters chlorine and releases minerals which makes it alkaline the minerals are Sodium, Potassium, Magnesium and Calcium.

5) The said filter in claim 1, as tested and claimed per filter are:
a. Duration 300 Gallons
b. Reduction chlorine (NSF 42) 85%
c. PH output 8.5-9
d. Alkalinity 90
